(19) United States
(12) Patent Application Publication
(10) Pub. No.: US 2016/0021520 A1
(43) Pub. Date: Jan. 21, 2016

(54) ALLOWING EMERGENCY CALL WHEN NO SERVICE IN UE IN CASE OF SHARED BANDS

(71) Applicant: QUALCOMM Incorporated, San Diego, CA (US)

(72) Inventors: Venkata NagaSujatha Gudu Gantla, Hyderabad (IN); Venkata Appala Naidu Babbadi, Hyderabad (IN); Appala Naga Raju Bodduru, Hyderabad (IN)

(21) Appl. No.: 14/332,841

(22) Filed: Jul. 16, 2014

(51) Int. Cl. H04W 4/22; H04W 72/04

(52) U.S. Cl. CPC H04W 4/22; H04W 72/0453

(57) ABSTRACT

A method for enabling emergency calls on a mobile communication device includes: searching for available communication channels in one or more supported frequency bands and shared communication channels in one or more unsupported frequency bands; storing information including channel frequency and channel criteria about one or more available shared communication channels detected in the one or more unsupported frequency bands; and camping on one of the one or more available shared communication channels in one of the one or more unsupported frequency bands if no available communication channels exist in the one or more supported frequency bands.

### BACKGROUND

A mobile communication device typically supports communication in one or more frequency bands (bands) for one or more radio access technologies (RATs). When the mobile communication device is roaming, the mobile communication device may be in an area where only unsupported bands are available. For example, the mobile communication device may support Wideband Code Division Multiple Access (WCDMA) Band 5, but may be in an area where only WCDMA Band 6 cell is available or in an area where only a Global System for Mobile communications (GSM) cell is available.

The mobile communication device may try to camp on the Band 6 cell, but due to the band mismatch the mobile communication device will not camp on a cell in the unsupported band even though Band 5 and Band 6 may have frequency ranges that overlap. As a result, the mobile communication device may report “no service” because no suitable cells are available. Any network is required to support an emergency call regardless of the network the user belongs to, but the mobile communication device will reject a call if the mobile communication device is not in a supported band. Accordingly, even emergency calls will not be permitted in such roaming areas.

### SUMMARY

Systems and methods that enable a mobile communication device to camp on a shared channel of an unsupported band and permit the mobile communication device to make emergency calls using the shared channel are provided.

According to various embodiments there is provided a method for enabling emergency calls on a mobile communication device. The method may include: searching for available communication channels in supported frequency bands and shared communication channels in unsupported frequency bands; storing information including channel frequency and channel criteria about available shared communication channels detected in the unsupported frequency bands; and camping on one of the available shared communication channels in one of the unsupported frequency bands if no available communication channels exist in the supported frequency bands.

According to various embodiments there is provided a mobile communication device. The mobile communication device may include: a communications unit configured to communicate with a network; a storage; and a control unit.

The control unit may be configured to: cause the communications unit to search for available communication channels in supported frequency bands and shared communication channels in unsupported frequency bands, cause the storage to store shared channel information including channel frequency and channel criteria about available shared communication channels detected in the unsupported frequency bands, and cause the communications unit to camp on one of the available shared communication channels in one of the unsupported frequency bands if no available communication channels exist in the supported frequency bands.

According to various embodiments there is provided a mobile communication device. The mobile communication device may include: means for searching for available communication channels in supported frequency bands and shared communication channels in unsupported frequency bands; means for storing information including channel frequency and channel criteria about available shared communication channels detected in the unsupported frequency bands; and means for camping on one of the available shared communication channels in one of the unsupported frequency bands if no available communication channels exist in the supported frequency bands.

According to various embodiments there is provided a non-transitory computer readable medium having stored therein a program for making a computer execute a method for enabling emergency calls on a mobile communication device. The program may include computer executable instructions for performing steps comprising: searching for available communication channels in supported frequency bands and shared communication channels in unsupported frequency bands; storing information including channel frequency and channel criteria about available shared communication channels detected in the unsupported frequency bands; and camping on one of the available shared communication channels in one of the unsupported frequency bands if no available communication channels exist in the supported frequency bands.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a block diagram illustrating a mobile communication device according to various embodiments;

FIG. 2 is a diagram illustrating overlapping RAT frequency bands according to various embodiments; and

FIG. 3 is flowchart for a method according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

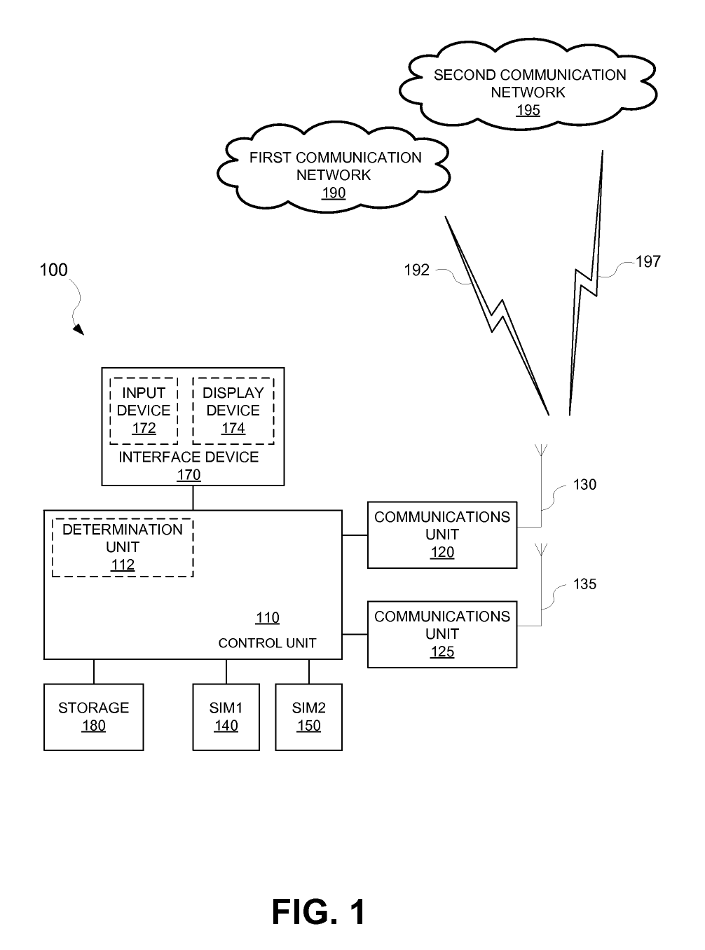

FIG. 1 is a block diagram illustrating a mobile communication device 100 (also referred to as a mobile device) according to various embodiments. As illustrated in FIG. 1, the mobile communication device 100 may include a control unit 110, a first communications unit 120, a second communications unit 125, a first antenna 130, a second antenna 135, a first Subscriber Identity Module (SIM) 140, a second SIM 150, a user interface device 170, and a storage 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communications units) and may interface with one or more antennas without departing from the scope of the present inventive concept. The mobile communication device 100 may be, for example, but not limited to, a Dual-SIM, Dual-Standby DSDS device, a Dual-SIM, Dual-Active (DSDA) device, a Multi-SIM, Multi-Standby (MSMS) device, or a Multi-SIM, Multi-Active (MSMA) device without departing from the scope of the present inventive concept.

The first communications unit 120 may include, for example, but not limited to, a first transceiver (not shown). The second communications unit 125 may include, for example, but not limited to, a second transceiver (not shown). In active mode, a transceiver receives and transmits signals. In idle mode, a transceiver receives but does not transmit signals.

The first SIM 140 may associate the first communications unit 120 with a first subscription (Sub1) 192 on a first communication network 190 and the second SIM 150 may associate the second communications unit 125 with a second subscription (Sub2) 197 on a second communication network 195. In active mode, a communications unit receives and transmits signals. In idle mode, a communications unit receives but does not transmit signals. For convenience, throughout this disclosure Sub1 is associated with the first communications unit 120 and Sub2 is associated with the second communications unit 125.

One of ordinary skill in the art will appreciate that either subscription may be associated with either communications unit without departing from the scope of the present inventive concept. Further, one of ordinary skill in the art will appreciate that a mobile communication device (e.g., the mobile communication device 100) may include only one communications unit (e.g., the first communications unit 120) and that two or more SIMs (e.g., the first SIM 140 and the second SIM 150) may associate their respective subscriptions with the one communications unit.

The first communication network 190 and the second communication network 195 may be operated by the same or different service providers, and/or may support the same or different communication technologies, for example, but not limited to, WCDMA and GSM.

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the present inventive concept.

The control unit 110 may be configured to control overall operation of the mobile communication device 100 including control of the first and second communications units 120, 125, the user interface device 170, and the storage 180. The control unit 110 may be a programmable device, for example, but not limited to, a microprocessor or microcontroller.

The control unit 110 may include a determination unit 112 configured to determine availability of communication channels in frequency bands supported by the mobile communication device 100. Alternatively, the determination unit 112 may be implemented as electronic circuitry separate from the control unit 110.

The storage 180 may be configured to store application programs necessary for operation of the mobile communication device 100 that are executed by the control unit 110, as well as application data and user data.

A mobile communication device (e.g., the mobile communication device 100) may support communication on one or more frequency bands (bands) for one or more RATs, for example, but not limited to WCDMA, GSM, etc. At times, for example, while roaming, the mobile communication device may be in an area where a network (e.g., the first communication network 190 or the second communication network 195) supports only bands other than the bands supported by the mobile communication device. The mobile communication device 100 may not camp on an unsupported band. Accordingly, even emergency calls will not be permitted in such roaming areas because the mobile communication device 100 may not have service.

The supported and unsupported frequency bands may have frequency ranges that overlap with frequency ranges of other bands (i.e., shared bands), and communication channels (channels) may be assigned to frequencies within the range of overlapping frequencies (i.e., shared channels).

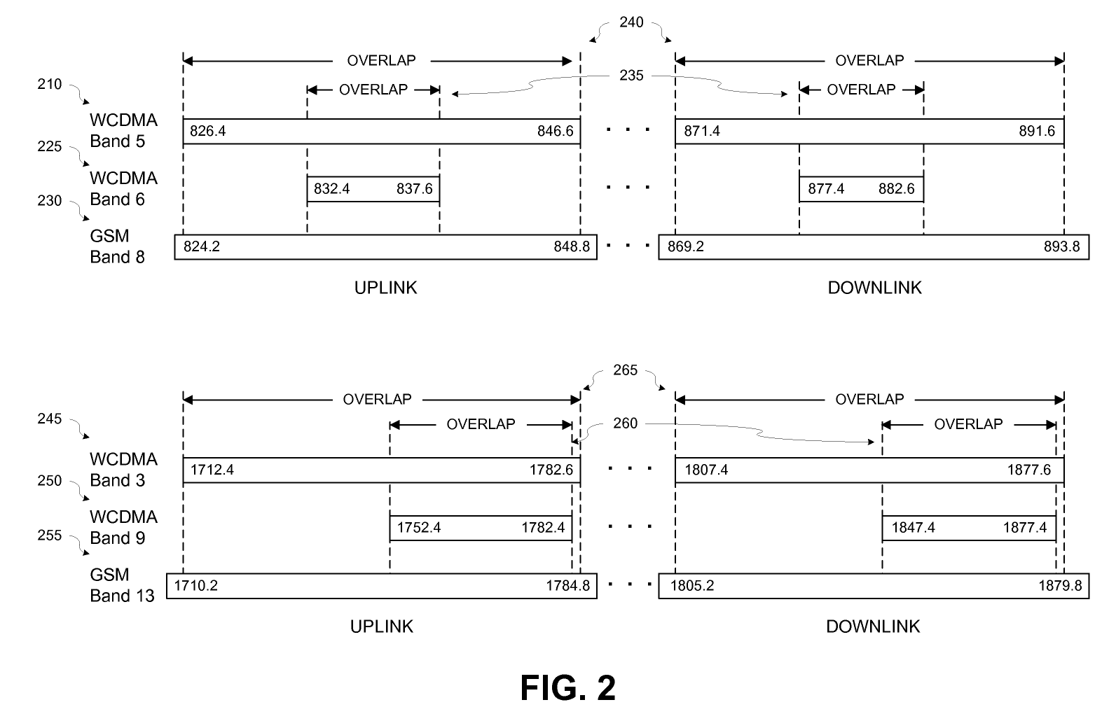

FIG. 2 is a diagram illustrating overlapping RAT frequency bands according to various embodiments. One of ordinary skill in the art will appreciate that the frequency bands illustrated in FIG. 2 are used for illustrative example and that other overlapping frequency bands in the same and/or other RATs are possible.

With reference to FIGS. 1-2, WCDMA Band 6 225 has an overlap 235 with WCDMA Band 5 210 and GSM Band 8 230 in the frequency range of about 832.4-837.6 MHz for the uplink and in the frequency range of about 877.4-882.6 MHz for the downlink. Also, WCDMA Band 5 210 has an overlap 240 with GSM Band 8 230 in the frequency range of about 826.4-846.6 MHz for the uplink and in the frequency range of about 871.4-891.6 MHz for the downlink. These frequency bands have a duplex spacing, i.e., a difference between uplink and downlink pairs, of 45 MHz.

Similarly, WCDMA Band 9 250 has an overlap 260 with WCDMA Band 3 245 and GSM Band 13 255 in the frequency range of about 1752.4-1782.4 MHz for the uplink and in the frequency range of about 1847.4-1877.4 MHz for the downlink. Also, WCDMA Band 3 245 has an overlap 265 with GSM Band 13 255 in the frequency range of about 1712.4-1782.6 MHz for the uplink and in the frequency range of about 1847.4-1887.4 MHz for the downlink. These frequency bands have a duplex spacing of 90 MHz.

Shared communication channels may be assigned to frequencies within the shared bands. System information included in a network broadcast indicates to which band a shared frequency (i.e., a shared channel) belongs. While a shared band may not be supported by the mobile communication device 100, the mobile communication device 100 may be capable of supporting an unsupported band, at least in the frequency ranges that overlap the shared band, to access a shared channel.

A mobile communication device (e.g., the mobile communication device 100) that can make a call on a channel in a supported band can also make a call in an unsupported band on a shared channel having the same duplex spacing as the channel in the supported band—there is no limitation from the device perspective. However, due to the band mismatch, the mobile communication device 100 may report a “no service” condition.

Various embodiments may enable a mobile communication device (e.g., the mobile communication device 100) to camp on a shared channel in an unsupported band and permit the mobile communication device to make emergency calls using the shared channel. Any network may identify an emergency call from specified header field information and is required to support the emergency call.

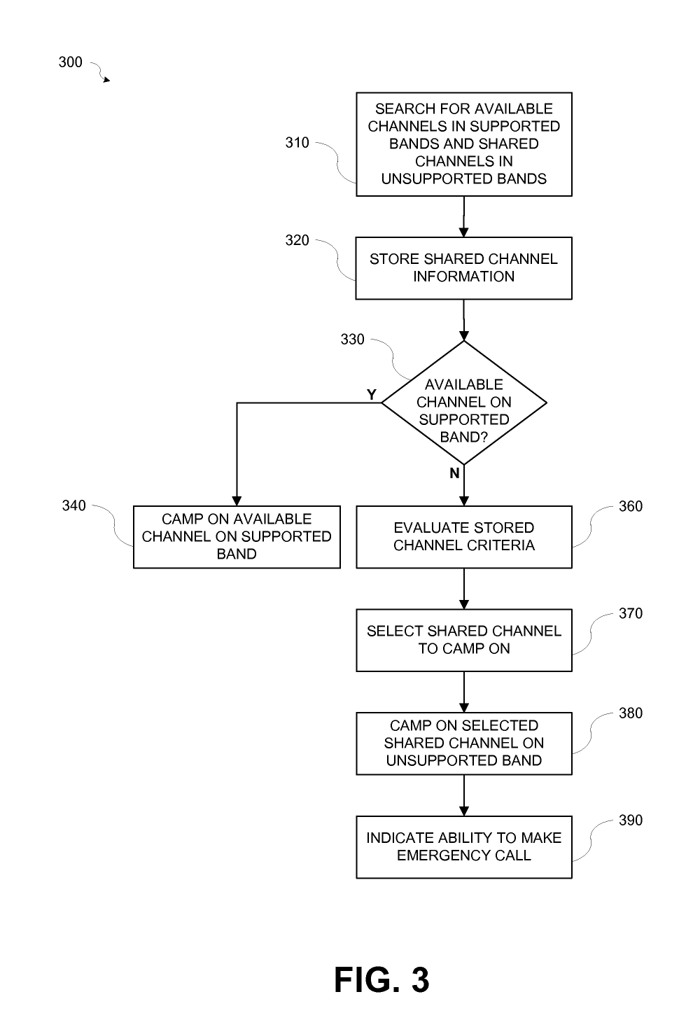

FIG. 3 is flowchart for a method according to various embodiments. With reference to FIGS. 1-3, the control unit 110 of the mobile communication device 100 may cause the communications unit (e.g., the first communications unit 120 or the second communications unit 125) to search for available channels in both supported bands and unsupported bands (310). Shared channels between the supported bands and unsupported bands may be detected in the overlapping frequency ranges of the supported bands and unsupported bands (e.g., see FIG. 2).

During a search of the supported bands, the control unit 110 may cause the storage 180 (e.g., a memory) to store frequencies of shared channels in unsupported bands. The system information broadcast by the network indicates the band to which a channel belongs. Information, for example, but not limited to, channel frequency and channel criteria, for example, but not limited to, signal strength, quality of service (QoS), signal-to-noise ratio (SNR), etc., regarding the available shared channels in the unsupported bands may be stored in the storage 180 of the mobile communication device 100 (320).

The determination unit 112 may determine whether a channel is available in a band supported by the mobile communication device 100 (330). If, after following procedures for determining a channel to camp on, a channel is available in a band supported by the mobile communication device 100 (330-Y), the mobile communication device 100 may camp on the available channel in the supported band (340). With the mobile communication device 100 camped on an available channel in a supported band, normal communication services may be available.

If, after following procedures for determining a channel to camp on, a channel is not available in a band supported by the mobile communication device 100 (330-N), the mobile communication device 100 may evaluate the stored channel criteria for the shared channels (360) and may select a shared channel to camp on based on the evaluation of the stored shared channel criteria (370). The mobile communication device 100 may camp on the selected shared channel in an unsupported band (380) and may provide a visual display on the display device 174 of the interface device 170 or otherwise indicate the ability for limited service on the camped-on shared channel to make an emergency call (390). The visual indication may be for example, but not limited to, an icon, a graphic indicator, a text message, etc.

In some embodiments, the method may be performed for shared bands for the same RAT, for example (but not limited to), WCDMA-WCDMA.

In some embodiments, the method may be performed for shared bands between different RATs, for example (but not limited to), WCDMA-GSM.

The accompanying claims and their equivalents are intended to cover such forms or modifications as would fall within the scope and spirit of the protection. For example, the example apparatuses, methods, and systems disclosed herein can be applied to multi-SIM/multi-RAT wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A method for enabling emergency calls on a mobile communication device, the method comprising:
searching for available communication channels in supported frequency bands and shared communication channels in unsupported frequency bands;
storing information including channel frequency and channel criteria about available shared communication channels detected in the unsupported frequency bands; and
camping on one of the available shared communication channels in one of the unsupported frequency bands if no available communication channels exist in the supported frequency bands.

2. The method of claim 1, further comprising indicating an ability to make an emergency call on the camped-on shared communication channel.

3. The method of claim 1, wherein the available shared communication channels in the unsupported frequency bands are in an overlapping frequency range between the supported frequency bands and the unsupported frequency bands.

4. The method of claim 1, wherein the available shared communication channels in the unsupported frequency bands have a same duplex spacing as communication channels in the supported frequency bands.

5. The method of claim 1, further comprising:
determining whether a communication channel is available in a supported frequency band; and
selecting a shared communication channel to camp on based on an evaluation of the stored information when a communication channel is not available on a supported frequency band.

6. The method of claim 1, wherein the unsupported frequency bands are shared frequency bands having a range of frequencies that overlap with frequencies in the supported frequency bands.

7. The method of claim 6, wherein the shared communication channels are assigned to frequencies in the shared frequency bands.

8. The method of claim 7, wherein the shared communication channels have a same duplex spacing in the unsupported frequency bands as in the supported frequency bands.

9. The method of claim 1, wherein the supported frequency bands and the unsupported frequency bands are frequency bands for the same radio access technology.

10. The method of claim 9, wherein the supported frequency bands and the unsupported frequency bands are frequency bands for Wideband Code Division Multiple Access (WCDMA) radio access technology.

11. The method of claim 1, wherein the supported frequency bands and the unsupported frequency bands are frequency bands for different radio access technologies.

12. A mobile communication device, comprising:
a communications unit configured to communicate with a network;
a storage; and
a control unit configured to:
cause the communications unit to search for available communication channels in supported frequency bands and shared communication channels in unsupported frequency bands,
cause the storage to store shared channel information including channel frequency and channel criteria about available shared communication channels detected in the unsupported frequency bands, and
cause the communications unit to camp on one of the available shared communication channels in one of the unsupported frequency bands if no available communication channels exist in the supported frequency bands.

13. The mobile communication device of claim 12, further comprising a determination unit configured to determine whether a communication channel is available in a supported frequency band,
wherein the control unit is configured to select a shared communication channel to camp on based on an evaluation of the stored channel criteria when a communication channel is not available on a supported frequency band.

14. The mobile communication device of claim 12, further comprising a display device configured to provide a visual display,
wherein the control unit is configured to cause the display device to display a visual indication that limited service for making an emergency call is available.

15. The mobile communication device of claim 12, wherein the unsupported frequency bands are shared frequency bands having a range of frequencies that overlap with frequencies in the supported frequency bands.

16. The mobile communication device of claim 15, wherein the shared communication channels are assigned to frequencies in the shared frequency bands.

17. The mobile communication device of claim 16, wherein the shared communication channels have a same duplex spacing in the unsupported frequency bands as in the supported frequency bands.

18. The mobile communication device of claim 12, wherein the supported frequency bands and the unsupported frequency bands are frequency bands for the same radio access technology.

19. The mobile communication device of claim 18, wherein the supported frequency bands and the unsupported frequency bands are frequency bands for Wideband Code Division Multiple Access (WCDMA) radio access technology.

20. The mobile communication device of claim 12, wherein the supported frequency bands and the unsupported frequency bands are frequency bands for different radio access technologies.

21. A mobile communication device, comprising:
means for searching for available communication channels in supported frequency bands and shared communication channels in unsupported frequency bands;
means for storing information including channel frequency and channel criteria about available shared communication channels detected in the unsupported frequency bands; and
means for camping on one of the available shared communication channels in one of the unsupported frequency bands if no available communication channels exist in the supported frequency bands.

22. A non-transitory computer readable medium having stored therein a program for making a computer execute a method for enabling emergency calls on a mobile communication device, said program including computer executable instructions for performing steps comprising:
searching for available communication channels in supported frequency bands and shared communication channels in unsupported frequency bands;
storing information including channel frequency and channel criteria about available shared communication channels detected in the unsupported frequency bands; and
camping on one of the available shared communication channels in one of the unsupported frequency bands if no available communication channels exist in the supported frequency bands.
